(19) United States
(12) Patent Application Publication
(10) Pub. No.: US 2021/0284554 A1
(43) Pub. Date: Sep. 16, 2021

(54) PROCESS FOR PRODUCTION OF LITHIUM BATTERY ELECTRODES FROM BRINE

(71) Applicant: LIEP ENERGY LTD., Calgary (CA)

(72) Inventor: Michael MISLAN, Calgary (CA)

(21) Appl. No.: 16/646,061

(22) PCT Filed: Apr. 29, 2019
(86) PCT No.: PCT/CA2019/000056

§ 371 Date: Mar. 10, 2020

(30) Foreign Application Priority Data
May 10, 2018 (CA) 3003245

(51) Int. Cl. C02F 1/461; H01M 10/0525; C02F 1/24; C02F 1/44; H01M 10/44; C02F 1/52

(52) U.S. Cl. CPC C02F 1/46109; H01M 10/0525; C02F 1/24; C02F 2103/08; H01M 10/44; C02F 1/52; C02F 1/447

(57) ABSTRACT

A method of manufacturing electrodes from a lithium-containing brine, said method comprising the steps of: providing an electrochemical cell comprising at least a cathodic chamber filled with a lithium-containing brine; contacting a lithium-intercalating electrode material with the lithium-containing brine; applying an electrical current to the cell for a duration sufficient to allow intercalation of lithium from the brine onto electrode material; and stopping the electrical current.

### FIELD OF THE INVENTION

The technical field relates to the extraction of lithium from brines and a process for the mass production of lithium battery electrodes.

### BACKGROUND OF THE INVENTION

Lithium ion batteries have emerged to become the dominant electrochemical energy storage technology due to their ability to provide high specific energy density and charging behavior over hundreds to thousands of recharge cycles. The accelerating production of electric vehicles, renewable energy storage systems, drones, electronics and robotics suggests the demand for batteries and hence new lithium sources and extraction processes must be developed to meet increasing demand.

Existing lithium production techniques from brines generally consist of two steps: the lithium content is first concentrated then transformed into a solid product for sale. Traditional techniques for the concentration of lithium include evaporation ponds, solvent extraction, membrane filtration, adsorption, selective precipitation and others but all seek to produce a liquid stream concentrated in lithium. In general caustic soda or similar alkali is added to the concentrated lithium solution to precipitate lithium carbonate or a similar lithium salt for sale. These processes often have high operational costs due to consumables such as acids or bases to changes pH, adsorbents which can granulate after multiple cycles or highly selective but expensive membranes which can quickly foul.

Brines comparable in composition to those found in the Lithium triangle have been discovered in produced oil field waters from evaporite carbonate reservoirs. Water treatment operations are ubiquitous to upstream facilities for the treatment of produced waters before reinjection or disposal. Consequently, over a hundred years of technical experience has accrued in this industry regarding the treatment of produced waters and the intention of this patent is to adapt these operations to extract lithium from brines in the form of a lithiated electrode material using the same principles which guide rechargeable lithium battery operation.

Common lithium ion battery electrode materials include metal oxides such as LiCoO₂, LiMn₂O₄, LiFePO₄, sulfur or potentially pure lithium metal on a support for the cathode coupled with an anode comprised of graphite, nickel or other potential materials depending on the desired anodic reaction, cell operating voltage, etc. Currently around half of battery prices derive from the cost of their electrodes and this has the potential to increase as strategic resources such as lithium or rare earth metals see increased demand as battery use proliferates.

Several strategies for the electrochemical extraction of lithium from brines have developed over the last decade. Electrodialysis systems often rely on lithium selective membranes to allow lithium to cross from an anodic chamber into a cathodic chamber to produce a relatively concentrated lithium stream in the catholyte. The lithium selective membranes are often advanced materials such as ion-impregnated organic frameworks, metal-organic frameworks and similar as cheaper membranes used in lithium batteries do not possess sufficient lithium selectivity. These new membrane technologies can experience operational issues related to fouling and poor cycling performance, which has prompted some researchers to attempt electrodialysis systems which separate other ions from the lithium-containing brine to better facilitate downstream processing steps.

Recent research has moved towards electrochemical lithium extraction systems which more closely resemble lithium batteries during charging/discharging in order to take advantage of cheaper, more commercially abundant materials. These processes involve contacting traditional metal oxide electrodes with brine on the cathode side whereby lithium is intercalated into the metal oxide crystalline lattice. Once the cathodes are fully saturated with lithium, the anolyte and catholyte flow streams are swapped and the lithium-bearing electrodes are now turned to anodic operation such that they generate a lithium-enriched stream for further processing into a salt product such as lithium carbonate or lithium hydroxide.

Presently, the lithium ion battery production supply chain consists of three types of businesses. Tier 1 suppliers produce lithium salts from ore or brine resources while Tier 2 suppliers create intermediate battery components such as ion exchange membrane separators or electrolytes. Tier 3 suppliers purchase the lithium salt to produce their battery electrodes and assemble the final lithium battery production with the additional inputs from Tier 2 suppliers. The process described herein this patent consolidates this supply chain to produce battery ready electrode products directly from lithium resources on site for the production of lithium ion batteries.

There is thus a very real need for a more efficient method of preparing lithium electrodes which overcomes at least one of the drawbacks of the prior art.

### SUMMARY OF THE INVENTION

According to the present invention, extraction of lithium from brines is achieved by introduction of electrode materials to a pre-processed brine stream such that lithium-containing electrodes can be mass produced for a wide range of battery applications and requirements.

According to one aspect of the present invention, there is provided a method of manufacturing electrodes from a lithium-containing brine, said method comprising the steps of:

providing an electrochemical cell comprising at least:
a cathodic chamber filled with a lithium-containing brine;

immersing a lithium-intercalating electrode into said brine in the cathodic tank;

applying an electrical current to the electrochemical cell for a duration sufficient of time for lithium ions present in the lithium-containing brine to be reduced and be deposited onto the electrode material.

Preferably, the method further comprises the step of pre-processing the lithium-containing brine to remove at least one contaminant prior to filling it into the cathodic chamber.

Preferably also, the electrode is a thin film. More preferably, the electrode film is in the form of a roll and which is positioned on a conductive substrate as the electrode is fed into the brine solution of the electrochemical cell.

According to a preferred embodiment, the electrode film is lithium deficient prior to the immersion into the lithium-containing brine in the cathodic tank

Preferably, the lithium-intercalating electrode is incorporated into at least one tray which has a plurality of wells of a predetermined shape, said well being adapted for the deposition of electrode materials.

According to a preferred embodiment, the pre-processing step involves at least one of the following operations:

removing dissolved gases in the produced fluid near the formation temperature in a crystallizer or similar vessel;

precipitating saturated carbonates;

removing any produced fines/sand.

removing hydrocarbons or other organic contaminants from the produced brine by using settling tanks and/or froth flotation and/or filtration;

removing halites and/or other potential highly saturated salts or silica which don't possess retrograde solubilities by using a second crystallizer at reduced temperature;

re-heating the brine before entering the electrochemical cell to improve kinetics, reduce saturation indices and possibly re-collect heat lost in the second, cooler crystallization step.

According to another aspect of the present invention, there is provided a system to perform lithium extraction from lithium-containing brines, said system comprising:

a cathodic tank allowing the insertion and removal of electrode trays thereinto;

electrodes integrated into a stack electrical system with connection to an anodic chamber to produce an electrochemical cell.

Preferably, the system operates in a semi-continuous or batch-wise manner. Preferably also, the cathodic chamber is filled with lithium containing brine.

According to a preferred embodiment, the anodic chamber is entirely or partially decoupled from the cathodic chamber such that it has a distinct electrolyte composition not derived from the brine but instead designed to conduct a particular anodic reaction on an appropriate anodic electrode surface.

According to another aspect of the present invention, there is provided a system to perform lithium extraction from lithium-containing brines, said system comprising:

a cathodic tank allowing the insertion and removal of electrode trays thereinto;

a lithium-containing brine to be placed in the tank; and

at least one electrode integrated into a stack electrical system with connection to an external energy source to produce an electrochemical cell.

According to another aspect of the present invention, there is provided a method of mass producing lithium-intercalated electrodes from a lithium-containing brine proximate the mining site of said lithium-containing brine, said method comprising the steps of:

obtaining said lithium-containing brine from a natural source;

removing contaminants from said brine;

providing an electrochemical cell comprising at least:
a cathodic chamber;

filling the cathodic chamber with said the decontaminated lithium-containing brine;

immersing a lithium-intercalating electrode into said brine in the cathodic tank;

applying an electrical current to the electrochemical cell for a duration sufficient of time for lithium ions present in the lithium-containing brine to be reduced and be deposited onto the electrode material.

Preferably, the step of removing contaminants from said brine comprises at least one of the operations selected from the group consisting of: removing dissolved gases in the produced fluid near the formation temperature in a crystallizer or similar vessel; precipitating saturated carbonates; removing any produced fines/sand; removing hydrocarbons or other organic contaminants from the produced brine by using settling tanks and/or froth flotation and/or filtration; removing halites and/or other potential highly saturated salts or silica which don't possess retrograde solubilities by using a second crystallizer at reduced temperature; and re-heating the brine before entering the electrochemical cell to improve kinetics, reduce saturation indices and possibly re-collect heat lost in the second, cooler crystallization step.

According to a preferred embodiment of the present invention, there is described a method to produce large numbers of electrodes, send them to the lithium resource and produce them on-site for the purpose of battery manufacturing. In general, the process described in this patent can be understood to some extent as being an adaptation of a prior art process but rather than having lithium enter the electrodes then swapping the flow pathways to produce a concentration lithium stream the lithium-saturated electrodes are instead replaced continuously with unsaturated electrodes.

An advantage of this process is that it eliminates potentially several intermediate steps which would otherwise be necessary in the life cycle from lithium resource in-situ to a finished battery product. In the typical process a lithium salt is produced from a brine or ore resource which requires separating the lithium ions from a mixed salt solution and processing the concentrated lithium stream into a salt product which is then shipped to battery manufacturers to produce lithium-containing electrodes and electrolytes.

Another advantage of this process is that it provides a flexible, scalable platform for the creation of battery electrodes with entirely dissimilar materials, properties, dimensions, etcetera but can be produced in parallel with each other to finally become lithium saturated together as part of the cathodic chamber electrode tray stack.

According to a preferred embodiment of the present invention, trays or similar modular, layered units are prepared to produce conductive plates or wells with specified dimensions which can be used with a chosen electrode synthesis technique and material to produce large sheets of electrodes which can be integrated into an appropriately designed electrochemical process system. Lithium containing brine resources are first pre-processed to remove contaminants such as hydrocarbons, precipitants, and potentially others before entering a cathodic tank containing the fabricated electrode trays. In cathodic operation, these electrodes intercalate lithium and following a sufficient residence time the trays can be removed together for shipment. The trays can then be dismantled, recycled and the lithium-bearing electrode plates recovered for immediate use in battery production.

According to a preferred embodiment, the electrode trays are to be designed in a modular, customizable fashion such that any design of electrode shape, material, conductive backing, etcetera can be created on a tray or similar platform which can be stacked with similar trays containing different electrodes to match customer design requirements. These trays can inexpensively be designed to be unique using computer-aided design programs then manufactured using traditional methods or using emerging automated techniques such as 3D printing, lithography, robotics or similar.

Battery manufacturing is a mature industrial field and as such there are a number of techniques for the synthesis of electrode materials, each of which requires slightly or significantly different process operation and inputs. Some examples include electrostatic spray deposition, sol-gel method, coating of inert, porous substrates with conductive layers, conductive fibres or foams, nanoparticulate and/or micropatterned electrode substrates and many others which could be implemented in the process proposed herein. In general, the prepared electrode trays are filled with an appropriate electrode material and processed to produce a final product ready for the field.

According to a preferred embodiment of the present invention, pre-processing of the brine is in general necessary to minimize fouling of the electrochemical system and any potential contamination of the electrode product. One preferred embodiment comprises of an initial de-gassing of the produced fluid near the formation temperature in a crystallizer or similar vessel to remove dissolved gases while precipitating saturated carbonates and removing any produced fines/sand. Preferably, hydrocarbons or other organic brine contaminants would also have to be removed by methods such as settling tanks, froth flotation, filtration, etc. This solution can then move to a second crystallizer at reduced temperature which can drop out halite and other potential highly saturated salts or silica which don't possess retrograde solubilities. Finally, the brine could be slightly re-heated before entering the electrochemical system to improve kinetics, reduce saturation indices and possibly re-collect heat lost in the second, cooler crystallization step. The particular brine pre-processing embodiment can vary considerably depending on the brine composition and properties, the only criteria is that the brine must be made chemically suitable to avoid fouling or contamination of the electrochemical system.

Many potential embodiments of the electrochemical system exist can be used, but it is preferable that there be a large cathodic tank with a mechanical design such that the fabricated electrode trays can be loaded into and out of the tank on a regular basis and the electrodes integrated into a stack electrical system with connection to an anodic chamber or similar electron source to produce an electrochemical cell. According to a preferred embodiment, in a semi-continuous or batch-wise manner the cathodic chamber is filled with brine and operated at relatively low cathodic voltage as set by a potentiometer, electrochemical control system or similar to minimize contaminating sodium intercalation into the electrode product as well as overpotential losses. Design of the anodic reaction is flexible and depends on economic and operational choices with respect to how much energy the electrochemical cell will consume or generate, whether the anodic reaction is compatible with brine as an anolyte or with a partially or entirely separate anolyte tank and composition. The anode and cathode chambers can be connected by an ion exchange membrane using any choice of cationic, anionic or other selectivity or designed to function separately given modifications to account for pH drift during operation. Once the cathodic electrode trays have sufficiently charged with lithium the system is put into a safe operating mode, drained, opened and the electrode trays removed for distribution and disassembly. Fresh electrodes are installed into the cathode tank system and the process repeated to produce large quantities of prepared electrodes for lithium ion batteries.

According to one embodiment of the present invention, the method comprises the following elements:

a. Manufacturing of the electrode tray, either by automated 3D printing, traditional techniques such as ‘calendaring’ or a combination. This tray consists of wells corresponding to the desired electrode dimensions, ideally with a copper, aluminum or similar electron collector at the well base which are electrically connected to the tray edge. Solution containing the desired electrode components such as FeCl3 and H3PO4 salts, with some polymeric binder and conductive additives, can be mixed then poured into the electrode moulds which could be hydraulically connected via raised channels connecting the wells. Other manufacturing methods may be substituted such as automated spray deposition, lithography, atomic layer deposition, etcetera to achieve different electrode materials, properties and performance.

b. The electrode tray wells now must be filled with the desired electrode material precursors and transformed into a solid electrode on the current collector plates by a chosen electrode synthesis technique. This step can take different forms depending on the desired final cathode product, ultimately the trays must be prepared for shipment to site, potentially protected by a covering and the electrodes need to be in a condition such that they're ready for introduction into the brine cathode compartment.

c. At the brine source, which may or may not be where the electrode trays are prepared, the brine is first pre-processed in order to remove contaminants, organic foulants and precipitating minerals which could foul the electrode trays or the electrochemical system generally.

d. Electrode trays are then introduced into a large cathodic tank which semi-continuously fills the tank with brine and electrically connected to the anodic chamber electrodes.

e. Voltage is applied or generated over a residence time necessary to fully saturate the cathodic electrode with lithium from the brine solution.

f. Following a sufficient residence time to saturate the electrode plates with intercalated lithium ions it should then be possible to remove the trays together, dry them and otherwise prepare them for shipment. Either the manufacturer or the customer could then disassemble the trays, return them for recycling and collect their custom designed electrodes.

According to a preferred embodiment of the present invention, during the electrode production process, at any appropriate point between steps a-f it may be beneficial to introduce additives to the electrodes such as doping agents, nanoparticles or similar to affect the final electrode composition and consequently its ultimate performance.

According to another embodiment of the method, the anodic compartment is converted into a microbial fuel cell whereby agricultural and other biological wastes could be introduced to the anodic tank and oxidized by heterotrophic, electrogenic microbial communities which can survive as biofilms on the electrode surface and use it as a sink for respirative electrons. The advantage of this technique is that it can simultaneously generate electricity and compost wastes into fertilizers while extracting lithium/producing lithium battery electrodes.

According to another embodiment of the method, the anodic chamber is entirely or partially decoupled from the cathodic chamber such that it has a distinct electrolyte composition not derived from the brine but instead designed to conduct a particular anodic reaction on an appropriate anodic electrode surface. Or the anodic tank is not included, and electrons are provided for the cathodic reaction by an external energy source rather than an anodic reaction.

According to another embodiment of the method, instead of extracting lithium from a natural or oil field produced brine this technique can be extended to any wastewater, blowdown or leachant stream which contains an economically sufficient lithium content. This process can be implemented in parallel with and connected to existing oil field, chemical, wastewater or similar process operations.

According to another embodiment of the method, the lithium-intercalating electrode material exists on a current collector backing in the form of a roll or similarly continuous sheet, which can be wound around a spool, spindle or similar and potentially incorporated into a cartridge or other container to minimize environmental contamination as well as facilitate transport, loading and unloading of the electrode roll from the electrochemical system described herein. The electrode roll can then be fed into and through an appropriately designed electrochemical system, passing over a current collector plate which applies a fixed current density and/or voltage such that lithium from lithium-containing brine is intercalated into the electrode as it passes through the system.

According to another embodiment of the method, a reference electrode of sufficient size and capacity is incorporated into the electrochemical system to provide better control over operating voltages.

### BRIEF DESCRIPTION OF THE FIGURES

Features and advantages of embodiments of the present application will become apparent from the following detailed description and the appended drawing, in which:

FIG. 1 is a diagram exemplifying one embodiment of the present invention for electrochemically extracting lithium from brine.

FIG. 2 illustrates a preferred embodiment of the first steps of the process of the present invention whereby electrode trays are prepared.

FIG. 3 illustrates a preferred embodiment of the process of the present invention to produce lithium battery electrodes.

FIG. 4 illustrates a preferred embodiment of the process of the present invention whereby lithium-intercalating electrodes are produced in an electrochemical unit operation using the roll to roll method.

FIG. 5 illustrates a preferred embodiment of the process of the present invention whereby lithium-intercalating electrodes are produced in an electrochemical unit operation using the roll to roll method without an incorporated membrane.

FIG. 6 illustrates a preferred embodiment of the process of the present invention whereby the roll-to-roll electrochemical electrode production method described herein is scaled up.

Exemplary embodiments of the present invention will now be described within.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention of the precise forms of any exemplary embodiment. Accordingly, the description and drawings are to be regarded in an illustrative, rather than a restrictive, sense.

The present description describes and relates to the extraction of lithium from brines to produce lithiated electrodes for battery manufacturing.

An advantage to the described production process is in its ability to provide a flexible range of products at scale. Each electrode well tray will contain cathodic or anodic with particular materials, dimensions, crystal structure, synthesis process, specific surface area, etcetera which can be manufactured by some form or combination of traditional plastic processing, 3D printing, automated lithography, etcetera according to desired specifications. Trays with different electrodes can then be stacked together in the cathodic brine compartments to accumulate lithium and can subsequently be removed and shipped as a stack. Therefore, many parallel electrode production streams can be operated simultaneously according to orders from clients, e.g. car battery electrode trays can intercalate lithium beside smaller drone battery electrode trays with the only cost being an increase in operational difficulty due to a more heterogenous electrode polarization geometry which will affect the systems overpotential. However, as the goal of this system is not to operate an ideal electrochemical system so much as saturate the cathodes this may manifest as a slight increase in necessary residence times, power consumption, etc.

As an example of electrode material fabrication methods, one preferred technique to produce a lithium-intercalating electrode material, iron phosphate, is to collect natural or genetically modified microbes from eutrophic aquatic ecosystems or wastewater treatment systems which have high phosphate concentrations contained within their cell membranes and introduce them into a solution containing Fe³⁺ ions. Some of the ions form intermediate complexes within and outside the cell membrane in solution before the system is dried overnight at 80° C. before being heated to 600° C. for 5 hours. The final product is a porous, thin film of FePO₄ with a small C content from the combusted cells. Such an electrode has demonstrated competent discharge capacity, a unique nanoparticulate microstructure from biological complexation and stable cycling performance suggesting that this or similar biotechnological techniques may be integrated into the electrode production process described herein. The advantage of such processes is that they utilize a cheap, available source of a desired compound, in this case phosphate, which would otherwise be an ecological hazard if in overabundance, and naturally remove this contaminant from the environment to produce a value-added product with potentially even superior performance capability.

According to another embodiment of the method, the electrode synthesis materials and techniques can fundamentally alter the initial electrode production process as described herein. An example of such would be the transition to a microwave synthesis process whereby microwave systems replace part or all of the traditional thermal drying and annealing steps. Such processes have demonstrated initial progress in proving a more uniform heating while reducing energy use and the necessary process time. Nanoparticulate, micropatterned, foam, conductive polymer gel, and similar emerging electrode material architectures can require additional processing steps and inputs not otherwise described herein.

In addition to being general to the cathodic lithium-intercalating electrode material chosen, the present description provides a multitude of potential anodic configurations, each of which possessing their own operational and economic advantages. The anodic electrode material and reaction should be considered an important degree of freedom in the design of this system, which can not only regulate how effectively the electrochemical system is able to extract lithium but can also determine whether the system as a whole consumes or produces energy. Should sufficiently robust electrode materials come available for industrial application it could be possible to evolve H₂ using a nickel anode or a similar method, generate oxygen or chlorine gas or a variety of similar value-added reduction products in the anodic tank. The electrode production technique described herein should also be understood to include anode electrode production as well, which would necessitate a modified design depending on electrolyte composition, anodic material and reaction, etc. According to another embodiment of the method, cathodic lithiation using this technique can be performed without a coupled anodic chamber but with a direct stream of electricity produced from other sources to the cathodic electrodes. Such a system can experience larger variation in cathodic chamber pH which may affect electrode stability, for example, but after lithium extraction, the depleted brine can be disposed similarly.

The pre-processing system design is dependent on the feedstock composition and properties, potential integration into existing processes, as well as the nature and abundance of components in the feedstock which can pose unique operational issues or contamination threats with respect to the electrochemical system and product. For example, depending on the risk of carbonate precipitation it may be necessary to incorporate larger unit operations into the pre-processing system such as a Hot Lime Softener (HLS). Ideally, this step should be avoided to minimize the requirement for additional process inputs such as soda lime and to maintain the brine stream pH within acceptable ranges that will not compromise factors such as electrode stability.

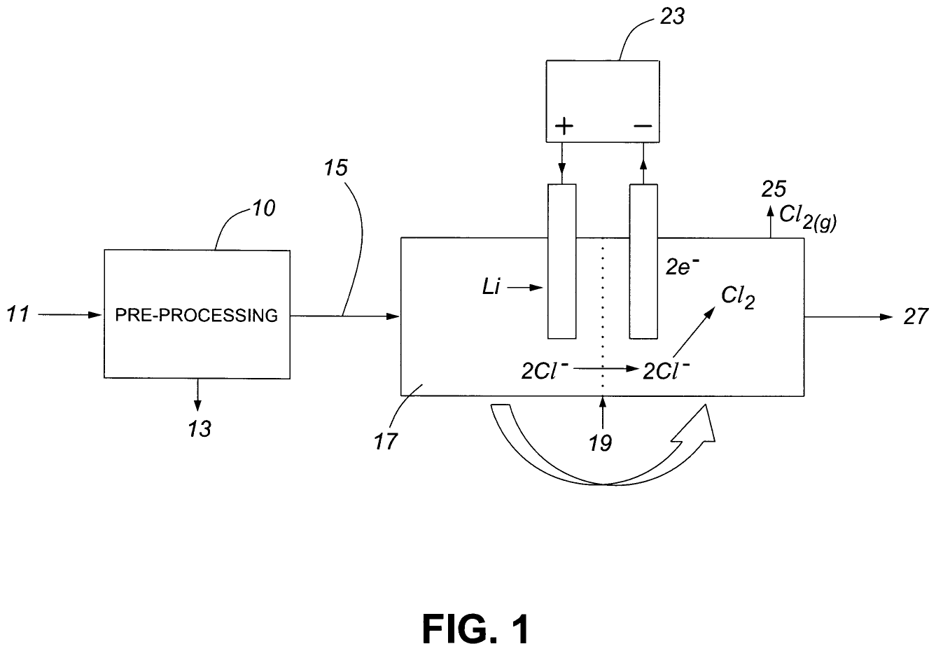

FIG. 1 illustrates a first preferred embodiment of the process described herein whereby produced brines (11) are pre-processed (10) to remove potential contaminants (exiting at 13) of the electrochemical system including hydrocarbons, precipitating salts and reservoir gases. This can be accomplished using a combination of typical oil field and similar water processing unit operations such as crystallizers, separation tanks, froth flotation tanks, membrane filtration, after filters, solvent extraction, etcetera. The decontaminated brine (15) is then used to fill a cathodic tank containing the fresh electrode trays and over a certain residence time during which electricity is added or removed from the system cell (23), the lithium intercalates into the electrode material to produce a saleable product. In this embodiment, the lithium-depleted brine is subsequently used to fill the anode tank to take advantage of low input requirements and the excellent electrolytic properties of the highly saline brine. The anode tank (21) and cathode tank (17) can be connected by an anionic exchange membrane (19) which would allow chloride ions to pass into the anolyte. In this example, the chloride oxidation reaction could take place on the anodic electrode to provide electrons for the cathode and produce another saleable product in the form of chlorine gas (25). The de-lithiated brine (27) is removed from the tank.

The profitability of this such a system depends in large part in the relative cost and operability of the anodic electrode which for the chloride oxidation reaction is often platinum, hence the motivation to seek alternative anodic systems which can be compatible with the brine or similarly cost-effective anolytes which can reduce power consumption or generate power or value-added products or services in addition to the cathodic lithium extraction. Once most of the lithium has been removed from the brine and assuming the pre-processing steps brought the brines into compliance with regulatory standards the brine can then be sent for disposal.

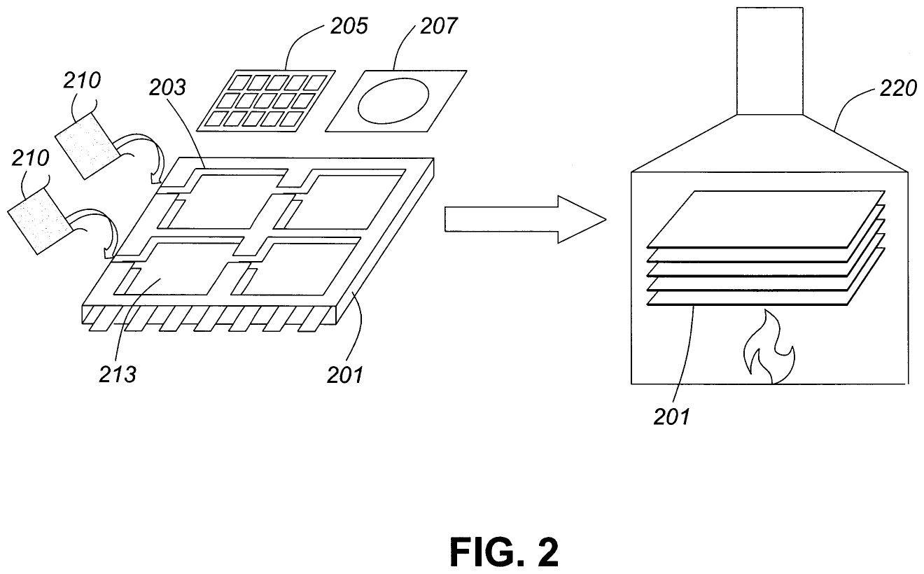

FIG. 2 illustrates the initial steps wherein electrode trays (201) are manufactured with customized specifications (alternative embodiments 205 and 207) but, in general, contain wells (203) or plates with conductive backing (213) upon which electrode materials can be deposited such that a separable but intact electrode product can ultimately be created. A simple example of an electrode material (210) and accompanying synthesis process would be the thermal production of FePO4, which can be accomplished by introduction of iron chloride and phosphoric acid solution into the wells. Then the trays (201) could be dried at 80-100° C. followed by annealing at 500-800° C. in an oven (220) for 5-12 hours depending on the synthesis process requirements to produce a crystalline product with appropriate charge and discharge performance.

FIG. 2 illustrates a common intermediate step in the production of electrode materials for batteries. The fabricated electrode trays (201) can be stacked and dried, then annealed together in air driers, ovens (220) or autoclaves.

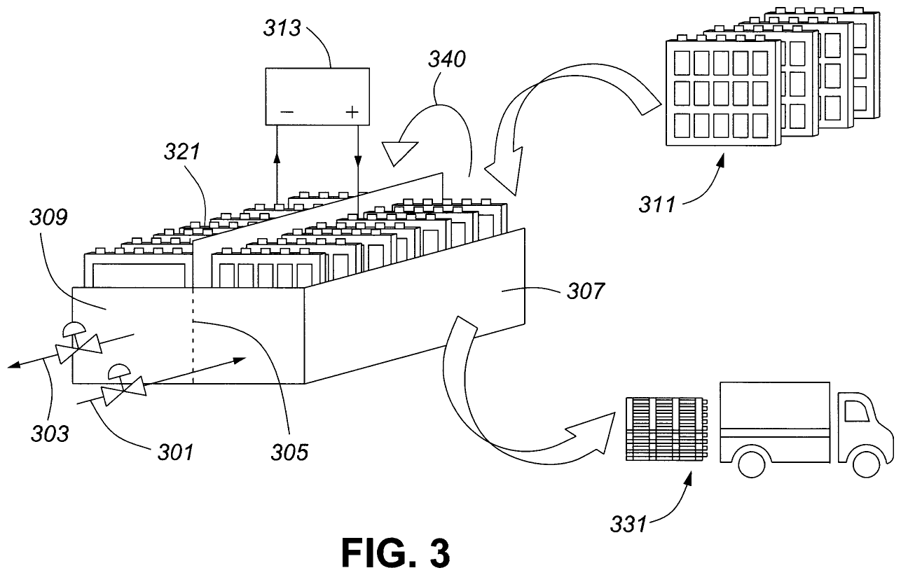

FIG. 3 illustrates a preferred embodiment for the electrochemical system (313) which will remove lithium from the produced brine by absorbing those ions into cathodic electrode material. The pre-processed brine (301) is fed into the cathode tank (307) which has been loaded with a fresh electrode tray stack (311). The cathode tank (307) is separated from the anode tank (309) by an anionic exchange membrane (305). The electrochemical cell system must be designed such that the electrode tray stacks are accessible, potentially by draining and opening the entire tank during every cycle of operation. The electrode tray stacks will have to rest on a rack or similar support system which is sufficiently easy to remove and replace trays. The trays (321) will also have to have some form of electrical connection around their outer edge or similar such that they can be electrically connected and integrated into the entire electrochemical cell (313) system as a stack. For a period of time, the electrochemical cell (313) is operated such that the cathodic lithium battery electrode charging reaction is able to take place and the brine becomes depleted in lithium. Once depleted of resource in this embodiment, the brine (see arrow 340) is reused as anolyte in the anode tank (309) before disposal (303) to take advantage of the high conductivity of brine and replacing the need for creating artificial electrolyte solutions.

FIG. 3 also illustrates how freshly fabricated electrode trays (311) which do not contain lithium are used to replace the lithium saturated electrodes following the necessary residence time.

FIG. 3 also illustrates the final step whereby the electrode tray stacks (331) are removed from the electrochemical system by a forklift, crane, or similar automatic or manual system to transport them for sale and distribution.

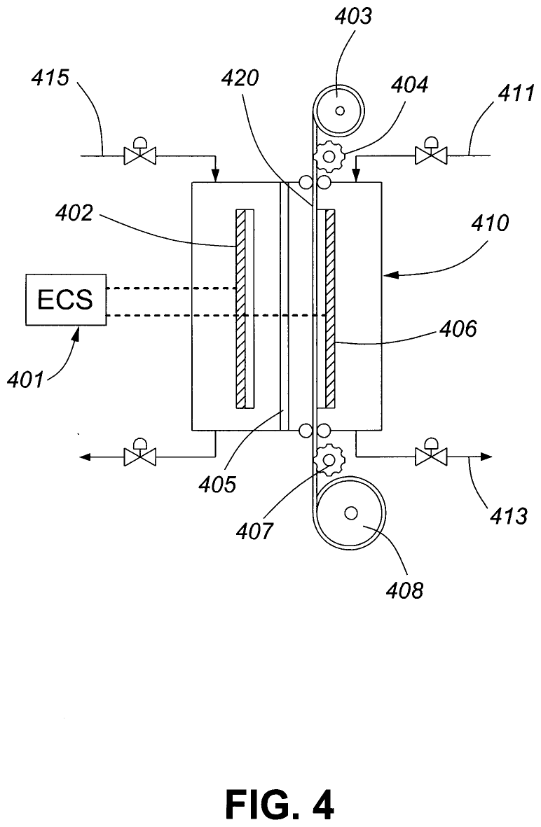

FIG. 4 illustrates a preferred embodiment for the electrochemical system which will remove lithium from the produced brine by intercalation into a suitable electrode material. In this embodiment, the lithium-intercalating material exists on a current collector backing which is in a roll (403) on a spindle and/or incorporated into a suitable cartridge which can be loaded into the unit operation and fed into the electrochemical system with assistance of a spool with a gear, such as the feed gear (404), which can assist the electrode tape stay in alignment as it feeds with the gear teeth gripping perforations in the electrode tape edge, similar to photographic film. The electrode tape (420) then feeds into the cathodic chamber filled with lithium-containing brine through the input (411) through rollers or similar before contacting the cathodic current collector (406) at which time lithium is intercalated into the electrode material, after which this electrode tape is then fed out of the anolyte chamber by the output gear (407) onto the output roll (408). The cathodic current collector (406) is connected to an electrochemical control system (ECS) (401) which determines the operating voltage and/or current in the electrochemical system, in addition to connecting the cathodic current collector (406) to the anodic current collector (402), completing the electrochemical circuit. In this embodiment, separating the anodic and cathodic containers is a membrane (405) such as an anion exchange membrane which can help maintain relatively constant pH during the electrochemical process to preserve electrode material stability. The lithium-depleted brine is removed from the system through the output (413). The anode tank is filled with a dilute aqueous solution (415).

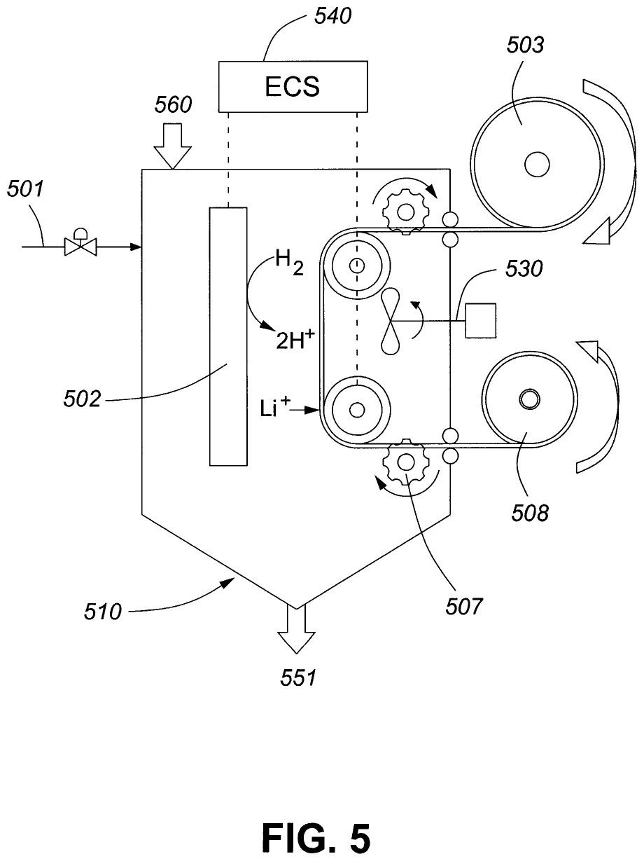

FIG. 5 illustrates a preferred embodiment for the electrochemical system which will remove lithium from the produced brine by intercalation into a suitable electrode material without incorporation of an internal membrane and/or separator. In this embodiment, hydrogen gas (560) is fed into the system to act as an electron donor via decomposition into protons on an appropriate anode (502). Current between the anode and cathode flows through an electrochemical control system, which interfaces with the overall distributed process control system and acts to manage the system's operating voltage and/or current density, with the assistance of a potentiostat system or similar, potentially incorporating a suitably designed reference electrode either in the brine chamber or in a separate electrolyte chamber. An electrode roll (503) is fed into the system with gear (504) and is passed over cathodic current collectors incorporated into spools over which the electrode tape (520) passes, causing intercalation of lithium from the brine into the electrode material. The electrode tape is then reeled in with gear (507) into roll (508). An agitator (530) is present in order to maximize the distribution of ions in the solution. The lithium-containing brine is inserted into the system via piping (501), the lithium-depleted brine is removed from the system via output piping (551).

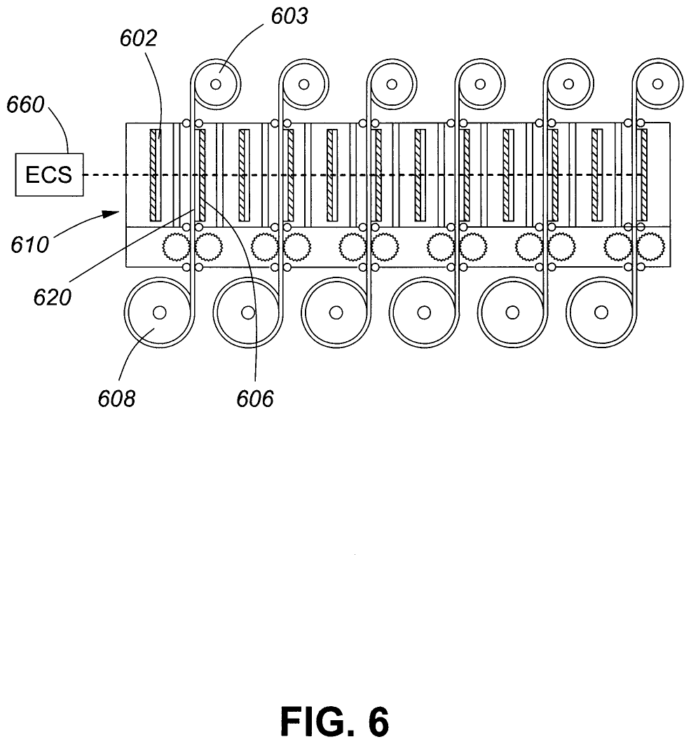

FIG. 6 depicts a preferred embodiment for scaling up the electrochemical system described herein by arranging the cathodic chamber (606) and anodic chamber (602) in such a way as to resemble a conventional electrochemical cell stack. As in FIG. 4, the electrode material (620) on a current collector backing is fed into the system from a roll (603) by revolution of a spindle, spool or similar, potentially with the assistance of gears, perforations in the tape for gear teeth, rollers and other equipment designed for the management of tape being fed through a system. The electrode tape then passes over a current collector which is connected to an electrochemical control system (ECS) which ensures cathodic operation such that the electrode material intercalates lithium from lithium-containing brine in the cathode chamber, filled and drained by piping and an associated system not shown for the sake of clarity. The ECS ensures coupling between the cathodic current collectors and an associated anodic electrode for each cell in the stack, itself conducting an anodic reaction using an appropriate electrode material in contact with a particular anolyte composition. In this particular embodiment, upon becoming fully intercalated with lithium the produced electrode tape is then fed through a cleaning system which uses a combination of chemical and physical mechanisms for removing contaminants which may have adsorbed themselves to the electrode surface during contact with the brine in the cathodic chamber before being fed onto a product roll (608).

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A method of manufacturing electrodes from a lithium-containing brine, said method comprising the steps of:
providing an electrochemical cell comprising at least:
a cathodic chamber filled with a lithium-containing brine;
immersing a lithium-intercalating electrode into said brine in the cathodic tank; and
applying an electrical current to the electrochemical cell for a duration sufficient of time for lithium ions present in the lithium-containing brine to be reduced and be deposited onto the electrode material.

2. The method according to claim 1, further comprising the step of pre-processing the lithium-containing brine to remove at least one contaminant prior to filling it into the cathodic chamber.

3. The method according to claim 1, wherein the electrode is a thin film.

4. The method according to claim 3, where the electrode film is in the form of a roll and which is positioned on a conductive substrate as the electrode is fed into the brine solution of the electrochemical cell.

5. The method according to claim 3, wherein the electrode film is lithium deficient prior to the immersion into the lithium-containing brine in the cathodic tank

6. The method according to claim 3, wherein the lithium-intercalating electrode is incorporated into at least one tray which has a plurality of wells of a predetermined shape, said well being adapted for the deposition of electrode materials.

7. The method according to claim 2, wherein the pre-processing step involves at least one of the following operations:
removing dissolved gases in the produced fluid near the formation temperature in a crystallizer or similar vessel;
precipitating saturated carbonates;
removing any produced fines/sand;
removing hydrocarbons or other organic contaminants from the produced brine by using settling tanks and/or froth flotation and/or filtration;
removing halites and/or other potential highly saturated salts or silica which don't possess retrograde solubilities by using a second crystallizer at reduced temperature; or
re-heating the brine before entering the electrochemical cell to improve kinetics, reduce saturation indices and possibly re-collect heat lost in the second, cooler crystallization step.

8. A system to perform lithium extraction from lithium-containing brines, said system comprising:
a cathodic tank allowing the insertion and removal of electrode trays thereinto; and
electrodes integrated into a stack electrical system with connection to an anodic chamber to produce an electrochemical cell.

9. The system according to claim 8 operating in a semi-continuous or batch-wise manner.

10. The system according to claim 8, wherein the cathodic chamber is filled with lithium containing brine.

11. The system according to claim 8, wherein the anodic chamber is entirely or partially decoupled from the cathodic chamber such that it has a distinct electrolyte composition not derived from the brine but instead designed to conduct a particular anodic reaction on an appropriate anodic electrode surface.

12. A system to perform lithium extraction from lithium-containing brines, said system comprising:
a cathodic tank allowing the insertion and removal of electrode trays thereinto;
a lithium-containing brine to be placed in the tank; and
at least one electrode integrated into a stack electrical system with connection to an external energy source to produce an electrochemical cell.

13. A method of mass producing lithium-intercalated electrodes from a lithium-containing brine proximate the mining site of said lithium-containing brine, said method comprising the steps of:
obtaining said lithium-containing brine from a natural source;
removing contaminants from said lithium-containing brine;
providing an electrochemical cell comprising at least:
a cathodic chamber;
filling the cathodic chamber with said decontaminated lithium-containing brine;
immersing a lithium-intercalating electrode into said decontaminated lithium-containing brine in the cathodic tank; and
applying an electrical current to the electrochemical cell for a duration of time sufficient for lithium ions present in the lithium-containing brine to be reduced and be deposited onto the electrode.

14. The method according to claim 13, wherein the step of removing contaminants from said lithium-containing brine comprises at least one of the operations selected from the group consisting of: removing dissolved gases in the produced fluid near the formation temperature in a crystallizer or similar vessel; precipitating saturated carbonates; removing any produced fines/sand; removing hydrocarbons or other organic contaminants from the produced brine by using settling tanks and/or froth flotation and/or filtration; removing halites and/or other potential highly saturated salts or silica which don't possess retrograde solubilities by using a second crystallizer at reduced temperature; and re-heating the brine before entering the electrochemical cell to improve kinetics, reduce saturation indices and possibly re-collect heat lost in the second, cooler crystallization step.
